(19) United States
(12) Patent Application Publication
(10) Pub. No.: US 2017/0021546 A1
(43) Pub. Date: Jan. 26, 2017

(54) APPARATUS AND METHOD FOR MANUFACTURING MESH-LIKE POLYMERIC STRUCTURES

(71) Applicant: Aquise-Wise Water Technologies Ltd., HERZLIYA (IL)

(72) Inventor: Nir ASSULIN, Kiryat Tivon (IL)

(21) Appl. No.: 15/124,391

(22) PCT Filed: Mar. 11, 2015
(86) PCT No.: PCT/IL2015/050256

§ 371 Date: Sep. 8, 2016

Related U.S. Application Data
(60) Provisional application No. 61/951,134, filed on Mar. 11, 2014.

(51) Int. Cl. B29C 47/12; B29C 47/00; B29C 47/24; B29C 47/86; B29C 47/06; B29C 47/92

(52) U.S. Cl. CPC B29C 47/128; B29C 47/065; B29C 47/92; B29C 47/24; B29C 47/864; B29C 47/0066; B29C 2947/92571

(57) ABSTRACT

A method and apparatus for manufacturing a combined polymeric structure are disclosed. The apparatus includes an extruder body (110), a die (120) configured to receive flowing polymeric material from the extruder body (110) and a motion unit. The die includes a hollow inner die (122), a protecting sleeve (124) located within the inner die (122) and an outer die (125) located at an exit (128) end of the hollow inner die (122). The motion unit is configured to cause bidirectional translational motion of the hollow inner die (122) relative to the outer die (125).

### BACKGROUND

Extrusion is one of the most common methods for manufacturing polymeric structures. Polymers have a low melting point and good fluidity, which is suitable for extrusion. Polymer resins in the form of chips or pellets are fed into an extruder body to be melted by heating elements and pushed forward by a lead screw. The lead screw forces the resin through a die, forming the resin into the desired shape. Extrusion is relatively a cheap and fast way for manufacturing simple polymeric structures such as tubing, pipes, rods, rails, seals, and sheets or even nets. This method, however, is not suitable for manufacturing complex structures.

### SUMMARY

Embodiments of the invention are directed to an apparatus for manufacturing a combined structure. The apparatus includes an extruder body and a die configured to receive flowing polymeric material from the extruder body. The die may include a hollow inner die, a protecting sleeve located within the hollow inner die and an outer die located at an exit end of the hollow inner die. The apparatus may further include a motion unit configured to generate bidirectional translational motion of the hollow inner die relative to the outer die.

Embodiments of the invention are directed to a method of manufacturing a combined polymeric structure. The method may include directing one or more solid elongated elements comprising polymeric material into a protecting sleeve located inside a die during extrusion of a polymeric mesh-like structure, extruding the mesh-like structure from the die while directing the elongated elements to exit the die and affixing the one or more elongated elements to an internal surface of the mesh-like structure to form the combined polymeric structure.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a high level block diagram of an apparatus for manufacturing polymeric elements according to embodiments of the invention;

FIG. 2 shows a cross section view of a die and extruder body according to embodiments of the invention;

FIG. 3 is an illustration of an exemplary combined structure manufactured according to some embodiments of the invention; and

FIG. 4 is a flowchart of a method of manufacturing a combined structure according to embodiments of the invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention are directed to an apparatus for manufacturing combined polymeric structures and a method of manufacturing same. The apparatus may include an extruder body and a die having a hollow inner die, an outer die located at the end of the hollow inner die and a protective sleeve within the hollow inner die to protect thermally sensitive parts that are intended to pass through the die during the extrusion process simultaneously with molten polymeric materials.

In some embodiments, the apparatus may generate a circumferential mesh-like structure and simultaneously provide one or more solid elongated elements, parts, rods or strips that are drawn from inside the apparatus to be connected to an internal surface of the extruded mesh structure. During manufacturing, molten polymeric material, i.e., plastic may be inserted via the extruder body to the die to form the extruded mesh-like structure while one or more solid thermally sensitive parts made, for example, from a solid polymeric material may be inserted into the hollow inner die without being melted of deformed. The thermally sensitive solid elements may be kept within the inner die in a solid state without deformation while the molten polymeric material passes through the hollow inner die due to the protecting sleeve. The protective sleeve may be an isolating element and alternatively or additionally may include a cooling element. The one or more solid elongated elements may exit the die from the same side as the circumferential mesh-like structure and may be joined to an internal surface of the extruded circumferential mesh-like structure when the extruded structure, still in liquid (melt) or glassy condition exits the die.

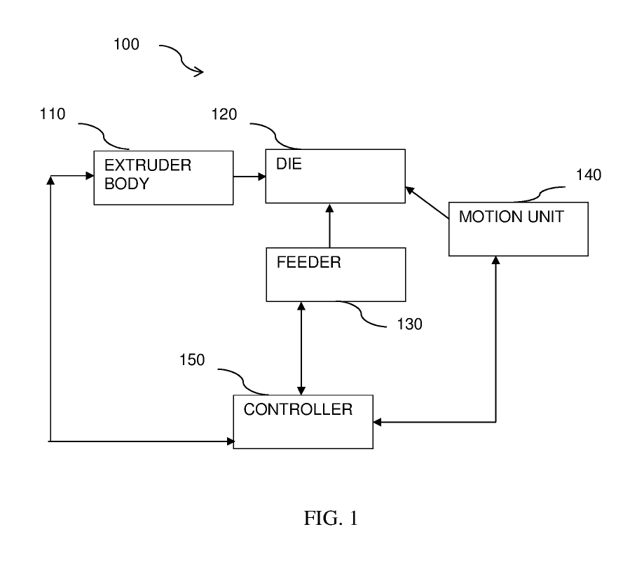

Reference is now made to FIG. 1, which shows a high-level block diagram of an exemplary apparatus for manufacturing a combined structure according to some embodiments of the invention. An apparatus 100, also referred to herein as a combined structure production system may include an extruder body 110, a die 120 coupled to the extruder body 110 and configured to receive molten polymeric material from the extruder body, a solid-elongated elements feeder 130 coupled to die 120 and configured to provide solid parts (e.g., solid elongated elements) to die 120, a motion unit 140 and a controller 150.

Controller 150 may be configured to control at least some of the elements included in apparatus 100, for example, extruder body 110, motion unit 140 and feeder 130. Controller 150 may include any computation platform that may be configured to control apparatus 100 according to code saved in a non-transitory memory associated with the controller, which when executed causes apparatus 100 to perform methods of the invention. Additionally or alternatively controller 150 may executed instructions received from a user using a user interface associated with controller 150. Controller 150 may include a processor (e.g., a CPU, microcontroller, programmable logic controller (PLC) and the like), a non-transitory memory for storing codes that when executed by the processor perform methods according to embodiments of the invention, and a user interface (e.g., a graphical user interface) that may include any devices that allow a user to communicate with the controller.

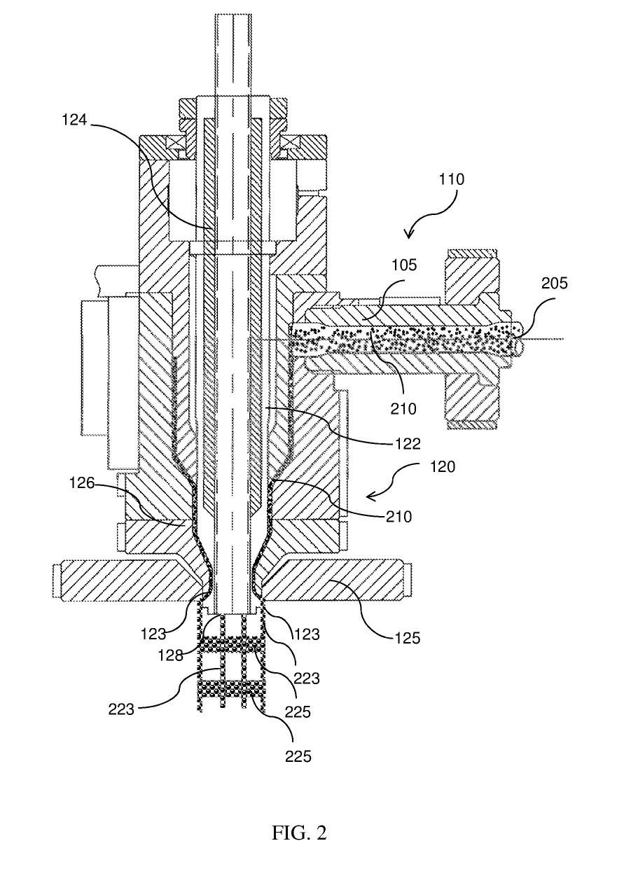

Reference is additionally made to FIG. 2, which shows a cross section of an extruder body and a die according to embodiments of the invention. An extruder body such as extruder body 110 may include a polymer inlet for introducing molten or solid polymer into apparatus 100. In some embodiments, the polymeric material may be introduced into the inlet in a solid state and may further be melted or soften inside extruder body 110. Extruder body 110 may include heating elements for melting or softening the inserted polymer. Extruder body 110 may include a tube 105 and lead-screw 205. Lead-screw 205 may lead the flowing polymeric material 210 also referred to herein as flowing polymer towards die 120. The flowing polymeric material may be injected out of die 120 from recesses (e.g., slots) included in die 120 to form a mesh-like structure also referred to herein as a perforated structure.

Die 120 may comprise a hollow inner die 122 having an opening 128 which serves as an exit end to solid parts, a protective sleeve 124 located inside hollow inner die 122 and an outer die 125 located around of inner die 122 in the vicinity of the exit end. Hollow inner die 122 may include a longitudinal bore (e.g., an open longitudinal cavity) to allow solid elongated elements to pass through die 120. Outer die 125 may be located at the exit end of hollow inner die 122, for example, in proximity to opening 128. In some embodiments, hollow inner die 122 and outer die 125 may be substantially coaxial with respect to each other. The inner die and the outer die may be substantially (e.g., with a tolerance of between ±0.001-10 mm, 0.001-0.01 mm, 0.01-0.1 mm, 0.1-1 mm and/or 1-10 mm) coaxial with respect to each other. Hollow inner die 122 may be located inside an external wall 126. The Molten polymer may be directed to a space between hollow inner die 122 and external wall 126.

Die 120 may have a set of recesses 123 (e.g., holes, slots and/or slits) at a desired arrangement through which the molten polymer is extruded to form the extruded mesh-like structure, The recesses may be located on an external surface of the hollow inner die 122 in proximity to opening 128, on an internal surface of outer die 125 or both. For example, recesses 123 may be located in a circumferential arrangement on the outer surface of hollow inner die 122. Flowing polymer 210 may exit through recesses 123 to form cords 223. In some embodiments, outer-die 125 may include a set of recesses (e.g., holes, slots and/or slits), such as recesses 123 at an inner surface of the outer die in proximity to an opening 128. The recesses may be located in a circumferential arrangement on the inner surface of outer die 125 towards and end/exit/opening 128 of die 120. Flowing polymer 210 may exit through the recesses to form cords 223.

Solid-part feeder 130 also referred to as solid elongate-element feeder may feed one or more solid elements into protecting sleeve 124 positioned within inner hollow inner die 122. Elongated element(s) may include one or more solid polymeric strips, ribbons, threads, cords, wires and the like. The one or more solid elements may be arranged in a predetermined desired arrangement according to the desired arrangement of these one or more elements in the final product or may be arbitrarily grouped together. In some embodiments, at least some of the elongated elements may be joined (e.g., welded, fused or glued) to other elongated elements, prior to feeding the solid elements into feeder 130. A plurality of elongated elements may be fed into protecting sleeve 124 such that the elongated elements may be substantially parallel to the longitudinal axis of inner die 120.

The one or more solid elements may exit die 120 from opening 128 simultaneously with the extrusion of the mesh-like structure from recesses (e.g., slots) 123 such that the solid elements are positioned in a space confined by the circumferential mesh-like structure and at least some of elongated elements are joined or affixed to an inner portion of the mesh-like structure, to form the combined structure. At least a portion of the one or more elongated elements may be joined to inner portion of the mesh-like structure by welding when the mesh like structure is still in a flowing (e.g., molten or semi-molten) state or by gluing when the mesh-like structure is in a solid state.

After exiting the die, the combined structure may be introduced to a holding (and optionally cooling and/or drying) system. The combined structure may be rolled, cooled and/or dried on support rollers. The combined structure may be further processed. For example, the combined structure may be cut to any desired length using any suitable cutting device or method.

Protective sleeve 124 may be configured to keep the solid elements within hollow inner die 122 at temperature below the melting temperature (Tₘ) or the glass transition temperature (T_{g}) of the polymeric material included in elongated elements. These elongated elements may include material(s) that are sensitive to elevated temperatures, and therefore they may be deformed when exposed to elevated temperatures. Such materials may include various polymers. The protecting sleeve may maintain elongated elements in a solid state inside hollow inner die 122 and may further prevent heat dissipated from the flowing polymer to melt or deform the one or more elongated elements.

Protecting sleeve 124 may include any cooling elements as known in the art, for example, protecting sleeve 124 may include a double wall cooling sleeve, a triple wall cooling sleeve or may include any other mechanism for cooling an inner surface of sleeve 124. Protecting sleeve 124 may include an active cooling unit, for example, a unit circulating cooling liquid (e.g., water) in the cooling sleeve or may be cooled passively by heat conducting methods. In some embodiments, protecting sleeve 124 may include any insulating element known in the art that may insulate the one or more elongated elements from heat dissipated from the flowing polymer. The insulating element may include for example, any insolating layer deposited on the inner surface of hollow inner die 122, an insulating sleeve located inside hollow inner die 122 or the like.

Protecting sleeve 124 may be located inside inner hollow inner die 122. Protecting sleeve may protect an inner space defined by sleeve 124 in which one or more elongated elements (not illustrated) are drawn towards opening 128. The inner space may be cooled or insulated from the dissipated heat to maintain a temperature below the melting point or the glass transition point of the polymeric material of the elongated elements so as to maintain the elongated elements in a solid state and to prevent major deformation of the elongated elements.

Motion unit 140 may be configured to cause or generate bidirectional translational motion of hollow inner die 122 and outer-die 125 relative to each other, for example, along the longitudinal dimension of hollow inner die 122. In some embodiments, motion unit 140 may further be configured to cause or generate rotational motion of inner die 122. Alternatively, a second separate motion unit may be configured to cause or generate rotational motion of hollow inner die 122. Controller 150 may be configured to control the one or more motion units to cause or generate the bidirectional translational motion and/or rotational motion of the inner die and/or the outer-die according to a predetermined sequence.

Motion unit 140 may cause hollow inner die 122 to touch outer die 125 such that flowing polymer 210 may exit only through recesses 123 to form cords 223. Additionally, motion unit 140 may cause hollow inner die 122 to detach from outer-die 125, forming a gap between hollow inner die 122 and outer-die 125, such that flowing polymer 210 may exit via the gap to form rings 225. Motion unit 140 may further be configured to cause rotational motion of hollow inner die 122 with respect to outer-die 125. The rotational motion may cause cords 223 to rotate, forming rotated cords (not illustrated). Motion unit 140 may include one or more motors (e.g., electrical, hydraulic or the like) to cause the motion of hollow inner die 122.

In some embodiments, a first motor included in unit 140 may cause the bidirectional translational motion and a second motor may cause the rotational motion. In some embodiments, a single motor may cause both motions and unit 140 may further include a gear for transferring rotational motion to translational motion and/or vice versa. In some embodiments, unit 140 may include more than one motor and more than one gear and at least one of the gears may transfer rotational motion to translational motion.

In some embodiments, an additional motion unit may cause the rotation of hollow inner die 122. The additional motion unit may include a motor and may further include a gear. In some embodiments, motion unit 140 or another motion unit may cause bidirectional translational motion and/or rotational motion of outer die 125 with respect to hollow inner die 122. The bidirectional translational motion may cause the formation of cords and rings and the rotational motion may cause the formation of diagonal cords, as disclosed above. The third motion unit may include at least one motor and optionally at least one gear.

A controller, for example, controller 150, may control motion unit 140 to cause the bidirectional translational motion of the inner die according to a predetermined sequence. The sequence may include attaching hollow inner die 122 to outer-die 125 to form cords 223 and detaching hollow inner die 122 from outer-die 125 to form rings 225. Additionally the controller may be configured to control motion unit 140 (or any other motion unit) to cause the rotational motion of hollow inner die 122 according to a predetermined sequence. The motion unit may be controlled to rotate hollow inner die 122 so as to form diagonal or rotated cords. In some embodiments, the controller may be configured to control motion unit 140 (or any other motion unit) to cause bidirectional translational motion and/or rotational motion of outer die 125 with respect to the hollow inner die 122. The bidirectional translational motion and/or rotational motion of outer die 125 may be according to a predetermined sequence as to form a mesh of any desired pattern.

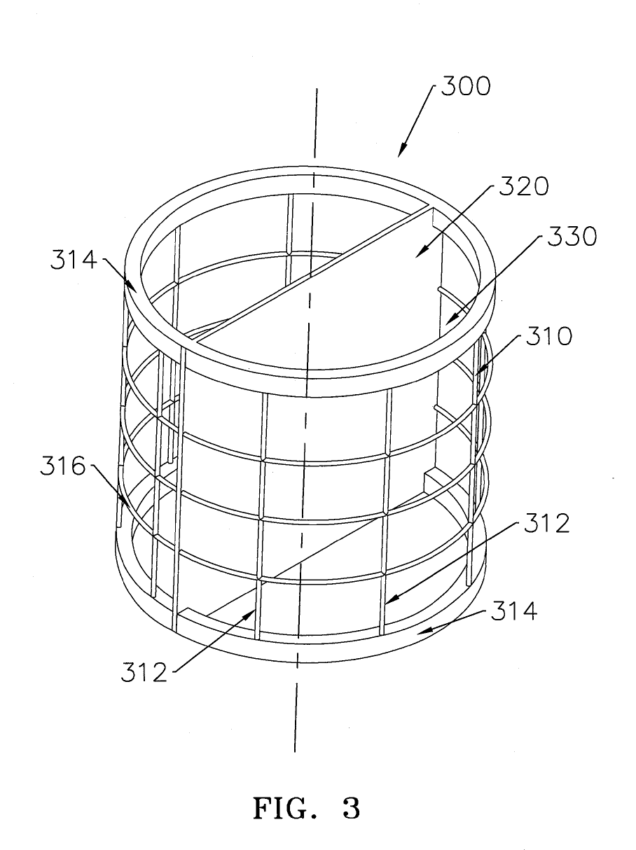

Reference is made to FIG. 3 illustrating an exemplary combined structure manufactured according to embodiments of the invention. A combined structure 300 may be manufactured using system 100. Combined structure 300 may be produced by cutting an elongated combined structure manufactured by apparatus 100 to a desired length. Combined structure 300 may include an extruded circumferential mesh-like structure 310 and one or more internal elements 320 positioned in a space 330 confined by the circumferential mesh-like structure. The spatial shape and cross sectional shape of the internal elements may vary and may include circular cross section, polygonal cross section and others. At least one of elements 320 may be joined to an inner area of mesh-like structure 310. In some embodiments, two or more elements 320 may be joined to the inner area of mesh-like structure 310. In some embodiments, two or more of elements 320 may be joined to each other. In the exemplary embodiment of FIG. 3 one element is shown. It should be understood, however, to a person skilled in the art that any other number of elements is within the scope of the invention. Further, it should be understood to a person skilled in the art that many other configurations and arrangements are within the scope of the invention.

As will be understood by a person skilled in the art, the invention is not limited to the exemplary meshes illustrated in FIG. 3 having an axial symmetry and rectangular holes. The invention may include any plastic mesh that may be manufactured by extrusion having holes in any shape and number.

Extruded mesh-like structure 310 may include a plurality of cords 312 connected by end rings 314 and inner rings 316. Exemplary structure 310 of FIG. 3 may include two end rings 314 and a plurality of substantially vertical cords 312. Exemplary extruded structures according to the invention may include around 0-25 inner rings 316 and around 3-80 cords 312. End ring 314 may be formed by detaching hollow inner die 122 from outer-die 125 for a longer period of time than the time for forming inner-rings 316. In some embodiments, extruded mesh 310 may include a plurality of rotated cords (or vertical/diagonal cord) crossing each other to form a rhombus mesh. The mesh may have a cylindrical shape, a wavy or any other shape. One or more solid elements 320 may include a material that is thermally sensitive. Such a material may undergo deformation when expose to elevated temperature, for example to a temperature above 115° C. . For example, one or more elements 320 may be plastic strips made from various polymers (i.e., plastics) such as, high density polyethylene (HDPE), polyethylene terephthalate (PET), low density polyethylene (LDPE) or polypropylene (PP). Elements 320 may have the same length as extruded circumferential mesh-like structure 310 Elements 320 may be flat or wavy, straight or curved. The surface of elements 320 may be smooth or rough and/or may be punched with small holes. At least some of elements 320 may be joined (e.g., welded, glued, or the like) to mesh 310 from at least one side, as illustrated.

In some embodiments, two or more elements 320 may be located inside space 330 in a pre-designed arrangement. Alternatively, two or more elements 320 may be located inside space 330 in an arbitrary arrangement. Combined structure 300 may have a relatively large surface area per volume ratio. In some embodiments, the combined structure may be a compressible object.

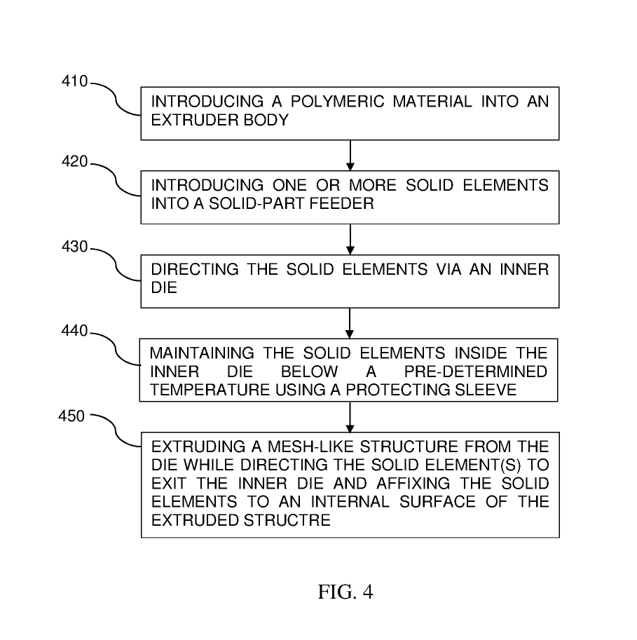

Reference is made to FIG. 4, which illustrates a flowchart of method of manufacturing a combined structure according to some embodiments of the invention. The method of FIG. 4 may be performed by a system such as system 100 illustrated in FIGS. 1 and 2. In box 410, the method may include introducing a polymeric material into an inlet in an extruder body, the polymeric material may be in a flowing state inside the extruder body. A solid polymeric material (e.g., in form of flexes) may be introduced via the inlet to be melted inside the extruder body using for example, heating elements included in the extruder body. Alternatively, a molten polymer may be introduced into the extruder body. The polymer may be led by a lead screw into an inner die designed to extrude mesh-like structures.

In box 420, the method may include introducing one or more solid elements (e.g., solid elongated elements) into a solid-part feeder (e.g., feeder 130). The solid elements may be one or more elongated elements arranged in a predetermined arrangement or may be arbitrarily located inside the feeder. The one or more solid elements may be comprised of a thermally sensitive material and may be deformed when exposed to elevated temperatures. Non-limiting examples of thermally sensitive materials may include a polymeric material, such as, HDPE, PET, LDPE or PP and the like.

In box 330, the method may include directing one or more solid elongated elements comprising polymeric material into a protecting sleeve (e.g., sleeve 124) located inside a die (e.g., die 120) during extrusion of a polymeric mesh-like structure. The elongated elements may be directed into a hollow inner die (e.g., hollow inner die 122) included in the die (e.g., die 120). The one or more elongated elements may be held substantially parallel to the longitudinal axis of the die.

In box 440, the method may include maintaining the solid elongated elements inside the inner die below a pre-determined temperature (e.g., below 115° C.) using a protecting sleeve. The one or more solid elongated elements may be protected inside the hollow inner die, for example, by isolating or cooling the internal hollow space (e.g., a bore) of the hollow inner die. The cooling may be done using any cooling element or cooling arrangement known in the art, for example, a cooling sleeve. The cooling sleeve may be cooled actively by circulating cooling liquid (e.g., water) in the cooling sleeve or may be cooled passively by heat conducting means. Additionally or alternatively, the protective sleeve may be insulated using any insolation material or element known in the art.

The hollow inner die may be cooled and/or insulated to a temperature below the melting point or the glass transition point of the polymeric material intended to be directed into the die during the extrusion process so as to maintain the elongated elements in a solid state and to prevent major deformation of the elongated elements. The cooling may be required due to heat conducted from the extruder die head.

In box 450, the method may include extruding the mesh-like structure from the die (e.g., die 120) while directing the one or more elongated elements via an opening (e.g., opening 128) in the die and affixing the one or more solid elongated elements to an internal surface of the mesh-like structure form the combined polymeric structure. The mesh-like structure may be extruded by causing bidirectional translational motion of the inner die relative to the outer die along its longitudinal axis while directing the one or more elongated elements toward an opening in the die such that upon exiting the die the elongated elements are encompassed by the mesh-like structure forming together the combined structure, for example, combined structure 300.

In some embodiments, the method may further include controlling the bidirectional translational motion of the hollow inner die to form the cords and rings (as illustrated in FIG. 3). For example, controller 150 may control motion unit 140 to attach the hollow inner die to the outer die such that the polymeric material is extruded via the recesses (e.g., recesses 123) to form the cords (e.g., cords 223 or cords 312), as illustrated in FIG. 2. In yet another example, controller 150 may control motion unit 140 to detach hollow inner die 122 from outer die 125 to form a space such that the polymeric material is extruded via the space to form a ring (e.g., rings 225, 314 or 316). In some embodiments, the method may further include rotating the hollow inner die around its longitudinal axis. Controller 150 may control motion unit 140 to rotate hollow inner die 122 as to form diagonal cords. Additionally or alternatively, the method may include rotating the outer die (e.g., die 125) around its longitudinal axis. Motion unit 140 or additional motion unit may rotate the outer die with respect to the inner die, as to form the rotated cords.

The hollow inner and outer dies may transnationally move relatively to each other and/or may also rotate relative to each other. The relations between the bidirectional translational motion and optionally the rotational motions may define the final mesh-like structure shape.

In some embodiments, the method may include joining at least a portion of the one or more solid elongated elements to an inner portion of the extruded circumferential mesh-like structure to form a combined structure. As the extruded circumferential mesh-like structure may exit the die, simultaneously the one or more elongated elements exit from the protecting sleeve, such that the one or more elongated elements are encompassed by the extruded circumferential mesh-like structure. In some embodiments, the polymer included in the extruded circumferential mesh-like structure may be still in a liquid or semi-liquid state and may be easily joined (e.g., fused) to the portion of the one or more solid elongated elements to form the combined structure. In another embodiment, the extruded circumferential mesh-like structure may be cooled to a solid state and may further be glued to the portion of the one or more solid elongated elements, using any glue known in the art. For example, the narrow side of one or more elongated elements may be welded or glued to the inner portion of the extruded circumferential mesh-like structure, as illustrated in FIG. 3

In some embodiments, the method may include cutting the elongated combined structure to a predetermined length. The cutting may produce a plurality of combined structures having a desired length forming for example, combined structure 300. The elongated combined structure may be cut, using any cutting apparatus known in the art.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An apparatus comprising:
an extruder body;
a die configured to receive flowing polymeric material from the extruder body, the die comprises a hollow inner die, a protecting sleeve located within the inner die and an outer die located in the vicinity of an exit end of the hollow inner die; and
a motion unit configured to generate a relative bidirectional translational motion between the hollow inner die and the outer die.

2. The apparatus of claim 1, wherein the protecting sleeve comprises a cooling element.

3. The apparatus of claim 1, wherein the protecting sleeve comprises an insulating element.

4. The apparatus of claim 1, wherein the protecting sleeve is configured to maintain a temperature within the inner die below a predetermined temperature.

5. The apparatus of claim 1, comprising solid-part feeder configured to provide solid elongated parts to the inner die.

6. The apparatus of claim 1, wherein the motion unit is further configured to generate rotational motion of the hollow inner die.

7. The apparatus of claim 1, comprising:
a controller configured to control the motion unit to generate the bidirectional translational motion according to a predetermined sequence.

8. The apparatus of claim 7, wherein the motion unit is further configured to generate rotational motion of the hollow inner die and the controller is further configured to control the motion unit to generate the rotational motion of the according to a second predetermined sequence.

9. The apparatus of claim 1, comprising:
an additional motion unit configured to generate rotational motion of the outer die.

10. A method of manufacturing a combined polymeric structure, comprising:
directing one or more solid elongated elements comprising polymeric material into a protecting sleeve located inside a die during extrusion of a polymeric mesh-like structure;
extruding the mesh-like structure from the die while directing the elongated elements to exit the die ;and
affixing the one or more solid elongated elements to an internal surface of the mesh-like structure to form the combined polymeric structure.

11. The method of claim 10, wherein the die comprises a hollow inner die holding the protecting sleeve located within the inner die and the method further comprises maintaining a temperature within the inner die below a predetermined temperature.

12. The method of claim 10, wherein the die comprises a hollow inner die and an outer die located in the vicinity of an exit end of the hollow inner die and extruding the mesh-like structure comprises generating a relative bidirectional translational motion between the hollow inner die and the outer die.

13. The method of claim 10, wherein extruding the mesh-like structure further comprises rotating the inner die around a longitudinal axis.

14. The method of claim 10, wherein extruding the mesh-like structure further comprises rotating the outer die around a longitudinal axis.

15. The method of claim 10, further comprising cutting the combined structure to a predetermined length.

16. The method of claim 10 further comprising:
introducing a polymeric material into an inlet in an extruder body, the polymeric material is in a flowing state inside the extruder body; and
providing the polymeric material is in a flowing state to the die.
